(19) United States
(12) Patent Application Publication
(10) Pub. No.: US 2012/0141780 A1
(43) Pub. Date: Jun. 7, 2012

(54) High-Refractive Index Powder and Production Method and Application of Same

(76) Inventors: Mikio Konno, Sendai-shi (JP); Daisuke Nagao, Sendai-shi (JP); Akira Watanabe, Sendai-shi (JP); Takafumi Kinoshita, Sendai-shi (JP); Takashi Tawasaki, Omuta-shi (JP)

(21) Appl. No.: 13/382,256

(22) PCT Filed: Jun. 30, 2010
(86) PCT No.: PCT/JP2010/061173

§ 371 Date: Feb. 10, 2012

(30) Foreign Application Priority Data
Jul. 9, 2009 (JP) 2009-162278
Feb. 12, 2010 (JP) 2010-029133

(51) Int. Cl. B32B 5/16; C08K 3/22; C01G 23/00; B29B 9/00; B82Y 30/00

(52) U.S. Cl. 428/328; 428/402; 428/403; 264/5; 524/413; 977/773

(57) ABSTRACT

A powder of a titanate compound of an alkaline earth metal (MTiO₃: M is one or two or more selected from the group consisting of Ba, Sr, Ca and Mg), having an average particle diameter of 50 nm or smaller, an average aspect ratio of 1.0 to 1.2 and a refractive index of 1.8 to 2.6, is useful as a high-refractive index powder.

### TECHNICAL FIELD

The present invention relates to a high-refractive index powder.

### BACKGROUND ART

In recent years, high-refractive index powders have been variously studied as fillers for antireflection materials, condenser materials, lens materials, high-dielectric materials and the like. Particularly high-refractive index powders having a particle size of several to several tens of nanometers are preferentially used because being excellent also in transparency.

As materials of high-refractive index powders having a particle size of several to several tens of nanometers, titanium oxide being transparent and having a high refractive index is studied (Patent Literatures 1 and 2). However, in the case where titanium oxide powder is added as a filler to a matrix material for forming a transparent film, and used, there is a problem that the matrix material is oxidized and the degradation thereof is promoted by the action of the photocatalytic activity which the titanium oxide has. In order to cope with the problem, a method is studied in which a coating composed of a material having no photocatalytic activity is formed on the periphery of a titanium oxide particle (Patent Literature 3).

As materials having a high refractive index, in addition to titanium oxide, titanate compounds of alkaline earth metals (MTiO₃: M is one or two or more selected from the group consisting of Ba, Sr, Ca and Mg), particularly barium titanate (BaTiO₃) or strontium titanate (SrTiO₃), are known (Patent Literatures 4 to 9).

On the other hand, a method is disclosed in which a barium titanate powder of 50 nm or smaller is filled in an acrylic (methyl methacrylate) resin (Non Patent Literature 1).

### CITATION LIST

### Patent Literature

Patent Literature 1: Japanese Patent Application Laid-Open Publication No. 2006-273209

Patent Literature 2: Republication WO 2006/022130

Patent Literature 3: Japanese Patent Application Laid-Open Publication No. 2004-018311

Patent Literature 4: Japanese Patent Application Laid-Open Publication No. 64-18904

Patent Literature 5: Japanese Patent Application Laid-Open Publication No. 8-239216

Patent Literature 6: Japanese Patent Application Laid-Open Publication No. 2002-275390

Patent Literature 7: Japanese Patent Application Laid-Open

Publication No. 2005-075714

Patent Literature 8: Japanese Patent Application Laid-Open Publication No. 2005-306691

Patent Literature 9: Japanese Patent Application Laid-Open Publication No. 2008-230872

### Non Patent Literature

Non Patent Literature 1: Polym. Eng. Sci. 49, 1069-1075 (2009)

### SUMMARY OF INVENTION

### Technical Problem

However, in the method described in Patent Literature 3, an additional process to form a coating is added and there is a case where the productivity decreases. Additionally, if a coating is not complete, there is a case where a sufficient suppression effect cannot be attained. The barium titanate powder in Non Patent Literature 1 exhibits remarkable aggregation of particles and there is a case where the light transmittance of a coating film formed by using the barium titanate powder remarkably decreases.

The present invention has been achieved in consideration of problematic points which such conventional high-refractive index powders have, and the present invention can provide an excellent high-refractive index powder which can be produced without being subjected to complicate processes, has no photocatalytic activity to promote the degradation of a matrix, can be filled densely in the matrix, has a good dispersibility on filling, and provides a coating material obtained by filling the powder and a transparent film obtained by coating the coating material which have both a high transmittance and a high refractive index.

Although Patent Literatures 4 to 9 prescribe particles as raw material powders for sintered compacts or high-dielectric materials and their production methods, no technical idea is disclosed and suggested to achieve an average particle diameter exactly controlled to 50 nm or smaller, which is necessary to provide transparency as optical powder, and an aspect ratio near 1, which is necessary to provide a high filling property to a matrix. Although Non Patent Literature 1 describes an improvement of the dielectric constant by filling of a barium titanate powder, no technical idea is disclosed and suggested, as in Patent Literatures 4 to 9, to achieve a high transparency and a high refractive index, which are necessary as optical applications.

### Solution to Problem

The present invention, in order to solve the above-mentioned problems, employs the following means.

(1) A powder of a titanate compound of an alkaline earth metal, having an average particle diameter of 50 nm or smaller, an average aspect ratio of 1.0 to 1.2 and a refractive index of 1.8 to 2.6 and comprising a compound represented by MTiO₃ (M is one or two or more selected from the group consisting of Ba, Sr, Ca and Mg) (a powder of a titanate compound of an alkaline earth metal (MTiO₃: M is one or two or more selected from the group consisting of Ba, Sr, Ca and Mg), having an average particle diameter of 50 nm or smaller, an average aspect ratio of 1.0 to 1.2 and a refractive index of 1.8 to 2.6).

(2) The powder of a titanate compound of an alkaline earth metal according to (1) described above, wherein the titanate compound of an alkaline earth metal is barium titanate (BaTiO₃) and/or strontium titanate (SrTiO₃).

(3) The powder of a titanate compound of an alkaline earth metal according to (1) described above or (2) described above, which is treated with a silane coupling agent.

(4) A production method of producing a powder of a titanate compound of an alkaline earth metal according to any one of (1) to (3) described above, comprising adding an alkaline earth metal and an alkoxytitanium to an alcohol having an alkoxy group, and then adding water thereto, wherein (A) an atom of the alkaline earth metal and a titanium atom contained in the alkoxytitanium are equimolar; and (B) concentrations of each components based on a total volume of the alcohol having an alkoxy group and the water after addition of the water are the following (i) to (iii): (i) 0.05 to 0.15 (mol/L) of the alkaline earth metal; (ii) 0.05 to 0.15 (mol/L) of the alkoxytitanium; and (iii) 10 to 30 (mol/L) of the water.

(5) A coating material for forming a transparent film, comprising a powder of a titanate compound of an alkaline earth metal according to any one of (1) to (3) described above, a matrix for forming a transparent film, and a solvent, wherein a volume fraction of the powder of a titanate compound of an alkaline earth metal is 5 to 60% by volume with respect to a total volume of the powder of a titanate compound of an alkaline earth metal and the matrix for forming a transparent film.

(6) The coating material for forming a transparent film according to (5) described above, wherein the matrix for forming a transparent film comprises a (meth)acrylic polymer and/or a (meth)acrylic monomer. The (meth)acrylic means methacrylic or acrylic.

(7) A transparent film formed of the coating material for forming a transparent film according to (5) described above or (6) described above, wherein the transparent film has a refractive index of 1.6 to 2.2 and an absorption coefficient (α) represented by the following expression (1) of 0.10 (μm⁻¹) or lower:

α=−2.303×(1/L)×log₁₀(I/I₀) Expression (1)

wherein L is a thickness of a coating film (μm), I₀ is an intensity of an incident light in the direction perpendicular to the coating film, I is an intensity of a transmitted light in the direction perpendicular to the coating film, and (I/I₀) is a transmittance.

(8) A base material with a transparent film, having the transparent film according to (7) described above formed singly or together with another film on a surface of the base material.

### Advantageous Effects of Invention

The present invention can provide a powder comprising a particle exhibiting little aggregation, being fine, being good in the filling property, and having a high refractive index; a coating material for forming a transparent film, a transparent film having a high refractive index and a high light transmittance, and a base material with a transparent film, made by containing the powder.

### DESCRIPTION OF EMBODIMENTS

The material of a powder suitable for the present invention is a titanate compound of an alkaline earth metal (MTiO₃: M is an alkaline earth metal atom(s) of one or two or more selected from the group consisting of Ba, Sr, Ca and Mg). M in MTiO₃ may represent a plurality of alkaline earth metal atoms (expressed as M1, M2, M3 and the like); when M represents two kinds of alkaline earth metal atoms, the titanate compound can be expressed as (M1ₓM2₁₋ₓ)TiO₃; and when M represents three kinds of alkaline earth metal atoms, the titanate compound can be expressed as (M1_{y}M2_{z}M3_{1-y-z})TiO₃. In the formulae, x, y and z are each a number greater than 0 and less than 1, and y+z is greater than 0 and less than 1. Values of x, y and z can be changed by feed amounts in the synthesis. For example, if the molecular numbers of barium and strontium are made identical, a barium strontium titanate represented by (Ba_{0.5}Sr_{0.5})TiO₃ can be obtained. In the present invention, preferable is at least one of barium titanate [BaTiO₃], strontium titanate [SrTiO₃] and a barium strontium titanate [(BaₓSr₁₋ₓ)TiO₃, wherein x is a number greater than 0 and less than 1]. Although these compounds are known to be generally high dielectric substances, the present invention pays attention to a point that these substances are transparent and have a high refractive index and nevertheless no photocatalytic activity, which titanium oxide has, and newly aims at application as a high-transmittance and high-refractive index filler for optics.

The powder according to the present invention has an average particle diameter of 50 nm or smaller, and preferably 5 to 45 nm. The average particle diameter takes part in the light transmittance, and a smaller particle diameter gives a more improved transmittance. If the average particle diameter is greater than 50 nm, the light transmittance decreases; and there is a case where the absorption coefficient of a transparent film made by coating a coating material for forming the transparent film made by filling such a particle in a matrix becomes greater than 0.10 (μm⁻¹). The average particle diameter can be measured by a transmission electron microscope or a particle size measuring apparatus using a dynamic light scattering method, but since the particle diameter by a dynamic light scattering method is liable to be affected and varied by the particle concentration, the viscosity or the solvent composition of a slurry (a liquid in which a powder is dispersed in the solvent) used for measurement, by measuring a maximum length (Dmax: a maximum length between two points on a contour of a particle image) and a maximum perpendicular length (DV-max: a shortest length connecting perpendicularly between two straight lines when the image is interposed between the two straight lines parallel with the maximum length) of a particle image acquired especially by using a transmission electron microscope, the geometric mean value (Dmax×DV-max)^{1/2} is defined as a particle diameter of the present invention. By measuring particle diameters of 100 or more particles by this method, the arithmetic average value is defined as an average particle diameter.

In the present invention, the ratio of a maximum length and a maximum perpendicular length (Dmax/DV-max) of a particle is defined as an aspect ratio, and by measuring the aspect ratios of the 100 or more particles whose particle diameters have been measured, the arithmetic average value is defined as an average aspect ratio. The average aspect ratio of the powder according to the present invention is 1.0 to 1.2. If the average aspect ratio is greater than 1.2, the anisotropy of the particle shape becomes large, and there is a case where the filling rate of the particle is not improved when the particle is filled in a matrix for forming a film.

The refractive index of the powder according to the present invention is measured by the following method. The powder according to the present invention is in the state of being dispersed in a solvent (an alcohol having an alkoxy group) when being produced, but after the solvent is replaced by a solvent (for example, N-methylpyrrolidone) which can dissolve a polymethyl methacrylate resin, which is one kind of a matrix for forming a transparent film, the polymethyl methacrylate resin weighed so that the powder has a predetermined volume fraction to the resin is added and mixed to disperse the powder and dissolve the resin, to thereby fabricate a coating material for forming a film. Then, the coating material is coated on a substrate by using a spin coater to form a coating film; and the refractive index of the coating film is measured using a thin-film refractive index measuring apparatus. Several refractive index values acquired by varying the volume fraction of the powder in several coating materials are plotted on a graph whose abscissa axis indicates the volume fraction of the powder and whose ordinate axis indicates the refractive index of the coating film. The plotted measured points are approximated by a straight line; the straight line is then extrapolated to a point of 100% of the volume fraction; and a refractive index value at the point is defined as a refractive index of the powder. The refractive index of the powder according to the present invention is 1.8 to 2.6, and preferably 1.9 to 2.6. With the refractive index of lower than 1.8, a remarkable effect as a high-refractive index powder cannot be attained; and the refractive index of greater than 2.6 is conceivably difficult to achieve by using a titanate compound of an alkaline earth metal.

The powder according to the present invention is optionally subjected to a treatment on the surface with a silane coupling agent. Here, the treatment with a silane coupling agent refers to chemically or physically adhering a hydrolyzed/condensed substance of the silane coupling agent on a surface of a powder. In the case where a transparent film is intended to be obtained, since a powder needs to maintain the state that the powder is not aggregated and dispersed in a coating material, in the present invention, a silane coupling treatment is carried out. A method of carrying out a silane coupling treatment on a particle of barium titanate or the like is disclosed in Non Patent Literature 1. However, the particle of Non Patent Literature 1 differs from the present invention in the point that the particle surface is coated further with a methyl methacrylate resin in addition to a silane coupling agent treatment. Even if such a treatment is carried out, the light transmittance of the coating film filled with the particle of Non Patent Literature 1 is decreased unlike the coating film according to the present invention.

The difference between the powder according to the present invention and the powder of Non Patent Literature 1 is conceivably due to a difference between the production methods of the particles. That is, the powder according to the present invention uses an alcohol having an alkoxy group as a solvent in the synthesis; by contrast, the powder of Non Patent Literature 1 differs in the point of using ethanol. The reason why unlike the powder of Non Patent Literature 1, the powder according to the present invention, only by being subjected to a silane coupling treatment, maintains a high dispersibility when being thereafter filled in a matrix for forming a film or even in a coating film after being coated, and improves the light transmittance of the coating film is that the powder according to the present invention is produced by a novel method, that is, a method in which after an alkaline earth metal and an alkoxytitanium are added to an alcohol having an alkoxy group, water is further added. The production method according to the present invention is novel in the point that an alcohol having an alkoxy group and an alkaline earth metal are simultaneously used. Examples of the alcohol having an alkoxy group include 2-methoxyethanol, 2-butoxyethanol, 2-t-butoxyethanol, 1-methoxy-2-propanol, 3-ethoxy-1-propanol and 3-methoxy-3-methyl-1-butanol. Above all, 2-methoxyethanol is suitably used.

The production method of the powder according to the present invention will be described taking the case of a barium titanate powder as an example. A metallic barium (purity: 99% or higher, made by Kanto Chemical Co., Inc.) and tetraethoxytitanium (purity: 97%, made by Tokyo Chemical Industry Co., Ltd.) are weighed in an inert atmosphere so that barium and titanium become equimolecular, added to 2-methoxyethanol (purity: 99% or higher, made by Wako Pure Chemical Industries, Ltd.) heated at 30 to 100° C., preferably at 50 to 90° C., and mixed for several to 10 hours to dissolve barium; and thereafter, water (distilled water) heated at 30 to 100° C., preferably at 50 to 90° C., is added. In this case, the concentrations of the metallic barium and the tetraethoxytitanium are made to become 0.05 to 0.15 (mol/L), respectively, based on the total volume of the 2-methoxyethanol and water. The concentration of the water is made to become 10 to 30 (mol/L) based on the total volume. Thereafter, the solution was held at 100° C., preferably 50 to 90° C., for several to 10 hours to cause the hydrolysis and the dehydrating condensation reaction of the dissolved barium and the tetraethoxytitanium to thereby form a barium titanate powder having an average particle diameter of 50 nm or smaller and an average aspect ratio of 1.0 to 1.2 in the solvent. As the reaction solvent, in addition to an alcohol having an alkoxy group like 2-methoxyethanol, and water, another solvent can be used, but the another solvent is not preferably used. In the case of using another solvent, the concentrations of an alkaline earth metal (metallic barium and the like), an alkoxytitanium (tetraethoxytitanium and the like) and water are calculated based on the volumes only of an alcohol having an alkoxy group, and water, excluding the another solvent.

This powder, unlike conventional powders, does never aggregate and maintains a high dipersibility during the silane coupling agent treatment, at the solvent replacement (the replacement from a solution of an alcohol having an alkoxy group to a solvent which can dissolve a matrix for forming a film) thereafter, at the fabrication of a coating material for forming a film by addition of the matrix for forming a film, and further even in a coating film obtained by coating the coating material. Hence, the coating film can exhibit both a high refractive index and a high transparency.

The silane coupling agent treatment is carried out by a method in which after a barium titanate powder is formed in a solvent, a predetermined amount of a silane coupling agent is added to the solvent with the temperature being held, and mixed for a predetermined time. It is preferable that right before the addition of the silane coupling agent, the dispersion of the powder is enhanced in advance by applying an ultrasound vibration to the liquid for several minutes. A silane coupling agent to be used is not especially limited, but is preferably one having a functional group easily reactive with a matrix for forming a film. In the case where the matrix is an acrylic resin, the silane coupling agent is preferably a methacryloxy, acryloxy or epoxy one or the like, and suitable examples are 3-methacryloxypropyltrimethoxysilane (MPTMS), 3-acryloxypropyltrimethoxysilane and 3-glicydoxypropyltrimethoxysilane.

For the liquid containing the powder after the coupling treatment, the solvent replacement is carried out from the 2-methoxyethanol solvent to a solvent which can dissolve a resin being a matrix for forming a film. Examples of the solvent which can dissolve the resin are N-methyl-2-pyrrolidone (NMP), methyl ethyl ketone, methyl isobutyl ketone, cyclohexanone, ethyl acetate, butyl acetate, toluene and xylene. Above all, NMP is suitably used. As a method of solvent replacement, centrifugal precipitation, fractionation distillation, ultrafiltration or the like is used.

A predetermined amount of a matrix for forming a transparent film is added to the liquid containing the powder after the solvent replacement. The addition amount of the matrix for forming a transparent film is such an amount that the volume fraction of the barium titanate powder is 5 to 60% by volume, preferably 8 to 55% by volume, with respect to the total volume of the barium titanate powder and the matrix for forming a transparent film. If the amount of the powder is smaller than this, there is a case where an effect of the powder addition cannot be attained; and if the amount is larger than this, there is a case where a highly transparent coating film cannot be obtained because the particle aggregates. Hence, either case is not suitable to the present invention. As a material for the matrix for forming a transparent film, a highly transparent resin is preferable, and examples thereof are low-molecular weight polyester resins, polyether resins, (meth)acrylic resins, epoxy resins, urethane resins and silicone resins. Above all, (meth)acrylic resins are especially preferable. Examples of, a monomer constituting a (meth)acrylic resin are methyl methacrylate, butyl methacrylate, methyl acrylate, ethyl acrylate, butyl acrylate, pentaerythritol triacrylate and dipentaerythritol hexaacrylate, but especially methyl methacrylate is suitably used. These materials for the matrix for forming a transparent film may be added as a polymer or a monomer constituting the polymer, but in the case of a monomer, since there is a risk in which the polymerization starts before coating and the property of the coating material comes to change, the addition of a polymer is preferable. It is preferable that after the polymer addition, the liquid is heated and held at 50 to 100° C. under mixing for a predetermined time to completely dissolve the polymer in the solvent. Thereafter, the liquid containing the powder, the matrix for forming a transparent film and the solvent is cooled to thereby obtain the coating material for forming a transparent film according to the present invention. It is preferable that the amount of the solvent with respect to the total amount of the barium titanate powder and the matrix for forming a transparent film is suitably regulated so that the viscosity of the coating material exhibits a value suitable to coating (several ten to several tens of thousand mPa·s).

By coating the coating material according to the present invention on a base material such as a resin- or glass-made one, a transparent film and a base material with a transparent film is obtained. It is preferable that right before coating, the dispersion of the powder is enhanced in advance by applying an ultrasound vibration to the liquid for several minutes. As a method of coating, used are a spin coat method, a bar coat method, a dip coat method, a gravure coat method, a doctor blade method or the like. The feature of the transparent film according to the present invention lies in having both a high refractive index and a high light transmittance. The refractive index of the transparent film according to the present invention is 1.6 to 2.2, and preferably 1.7 to 2.2. If the refractive index is lower than 1.6, the effect of the addition of a high-refractive index particle cannot be said to be attained; and a remarkably high refractive index exceeding 2.2 is conceivably difficult to acquire by the method of adding the powder to the matrix.

The coating film according to the present invention has an absorption amount of light (absorption coefficient) of a predetermined value or smaller, and exhibits a high light transmittance. The transmission and absorption of light by a medium is generally represented by Expression (2).

I=I₀×exp(−αL) Expression (2)

wherein I₀ is an intensity of light before the incidence; I is an intensity of light after the incidence; α is an absorption coefficient; and L is an optical path length, to which a film thickness corresponds in the case of a coating film. Both sides of Expression (2) are divided by I₀; thereafter, logarithms of both the sides are taken; further thereafter, both the sides are divided by (−L); and the natural logarithm is converted to a common logarithm to thereby obtain Expression (1).

α=−2.303×(1/L)×log₁₀(I/I₀) Expression (1)

If Expression (1) is applied to the film according to the present invention, L is a thickness (μm) of the film; I₀ is an intensity of an incident light in the direction perpendicular to the film; I is an intensity of a transmitted light in the direction perpendicular to the coating film; and I/I₀ is a light transmittance.

As understood from Expression (1), in the case where the thickness (L) of a coating film is fixed, the smaller the absorption coefficient (α), the larger the light transmittance (I/I₀) and the more the transparency of the film is improved. The absorption coefficient of the film according to the present invention is 0.10 (μm⁻¹) or lower (0 to 0.10 (μm⁻¹)); and for example, in the case of a film of 0.1 μm in thickness, the film has a high light transmittance of 99% or higher, and in the case of 1 μm, a high light transmittance of 90% or higher.

The transparent film according to the present invention, singly or together with another film, is formed on a surface of a base material such as a resin- or glass-made one, and the base material on which such a transparent film is formed has excellent optical properties due to the effects of a high refractive index and a high light transmittance which the transparent film according to the present invention has, and is used suitably as antireflection materials, condenser materials, lens materials and the like.

### EXAMPLES

Hereinafter, the present invention will be described more specifically by way of Examples and Comparative Examples.

### Example 1

A separable flask of 300 mL in volume was placed in a glove box whose atmosphere was replaced by a nitrogen gas. About 50 mL of 2-methoxyethanol (purity: 99% or higher, made by Wako Pure Chemical Industries, Ltd.) was charged therein, and 1.32 g (0.0096 mol) of a metallic barium (purity: 99% or higher, made by Kanto Chemical Co., Inc.) and 2.19 g (0.0096 mol) of tetraethoxytitanium (purity: 97%, made by Tokyo Chemical Industry Co., Ltd.) were further added. After the metallic barium and the tetraethoxytitanium were completely dissolved, the liquid was refluxed for 2 hours; and to the liquid under stirring in a constant-temperature bath held at 70° C., a liquid in which 32.4 g (1.8 mol) of water (distilled water) was diluted with 2-methoxyethanol by adjusting the amount of the 2-methoxyethanol so that the total liquid amount became 120 mL was added. The concentrations of the respective components at this time were 0.08 (mol/L) of barium and tetraethoxytitanium each and 15 (mol/L) of water. After the liquid was continuously stirred for 5 hours to allow the liquid to react, the liquid was cooled, and subjected to centrifugal separation at a centrifugal acceleration of 38,000 G to thereby obtain a precipitate. A part of the precipitate was dispersed in isopropyl alcohol (purity: 99.9%, made by Wako Pure Chemical Industries, Ltd.), dropwise placed on a membrane (collodion membrane) for collecting a fine sample, dried, and thereafter used for observation by a transmission electron microscope (TEM). The TEM observation used a transmission electron microscope made by JEOL Ltd., 2000FX, and was carried out under the condition of an acceleration voltage of 200 kV and an observation magnification of 200,000×.

The formation of particles having TEM images having a particle diameter of 50 nm or smaller and being polygonal and isotropic was confirmed by the TEM observation. For 100 particle images each, a maximum length (Dmax: a maximum length between two points on a contour of the particle image) of the particle image and a maximum perpendicular length (DV-max: a shortest length connecting perpendicularly between two straight lines when the image is interposed between the two straight lines parallel with the maximum length) were measured, and the geometric mean value (Dmax×DV-max)^{1/2} thereof was calculated as a particle diameter; and the arithmetic average value thereof was defined as an average particle diameter, and the average particle diameter was 21.0 nm. The ratio of a maximum length and a maximum perpendicular length (Dmax/DV-max) of the particle is defined as an aspect ratio; the aspect ratios of the 100 particles whose particle diameters had been measured were measured, and the arithmetic average value thereof was defined as an average aspect ratio; and the average aspect ratio was 1.05.

Then, a powder obtained by drying a part of the precipitate was used and subjected to powder. X-ray diffractometry. The acquired diffraction pattern coincided with the diffraction pattern of barium titanate, and it was confirmed that the reaction product (precipitate) was a barium titanate powder. The powder X-ray diffractometry used an X-ray diffractometer made by Rigaku Corp., RU-200A, and was carried out under the condition of an X-ray of Cu—Kα, a voltage of 40 kV, and a current of 30 mA.

Liquids obtained by adding the barium titanate powder and a powdery polymethyl methacrylate resin (PMMA, average molecular weight: 75,000, made by Wako Pure Chemical Industries, Ltd.) in predetermined proportions indicated in Table 1 to a solvent (N-methyl-2-pyrrolidone [NMP], purity: 99% or higher, made by Wako Pure Chemical Industries, Ltd.) were heated and stirred at 70° C. for 6 hours under refluxing to disperse the barium titanate powder and to simultaneously dissolve the PMMA. After the completion of heating the mixture, the mixture was cooled to room temperature over 3 hours with applying an ultrasound vibration to thereby fabricate a coating material.

The obtained coating material was dropwise placed on a silicone wafer base material, coated at a rotation frequency of 1,500 to 2,000 rpm for 30 sec by a spin coat method, and thereafter dried at 100° C. for 30 min to fabricate a coating film. The refractive index of the obtained coating film was measured by a thin-film refractive index measuring apparatus (a prism coupler, model: 2010, made by Metricon Corp.) using helium-neon laser light of 632.8 nm in wavelength as a light source. Refractive index values measured were plotted on a graph whose abscissa axis indicated the volume fraction of the barium titanate powder and whose ordinate axis indicated the refractive index value, and approximated by a straight line; and the straight line was extrapolated to a point of 100% of the volume fraction to calculate the refractive index of the barium titanate powder, and the refractive index thereof was 2.0.

Here, the formulation number 1-1 in Table 1 was data of a blank coating film composed only of a matrix.

TABLE 1

Formulation Number

| | 1-1 | 1-2 | 1-3 | 1-4 |
|---|---|---|---|---|
| NMP Mass (g) | 2.17 | 2.17 | 2.17 | 2.17 |
| Powder Mass (g) | 0 | 0.318 | 0.530 | 0.733 |
| PMMA Mass (g) | 0.276 | 0.212 | 0.170 | 0.129 |
| Powder Volume | 0 | 23 | 38 | 53 |
| Fraction (%) | | | | |
| PMMA Volume | 100 | 77 | 62 | 47 |
| Fraction (%) | | | | |
| Coating Film | 1.49 | 1.62 | 1.70 | 1.75 |
| Refractive Index | | | | |

### Example 2

The reaction was carried out as in Example 1, except for using 0.841 g (0.0096 mol) of a metallic strontium (purity: 99%, made by Sigma-Aldrich Corp.) in place of the metallic barium in Example 1, to thereby obtain a precipitate. A part of the precipitate was dispersed in isopropyl alcohol, and subjected to TEM observation as in Example 1, and the formation of particles having TEM images having a particle diameter of 50 nm or smaller and being polygonal and isotropic was confirmed. For the 100 particle images, the average particle diameter and the average aspect ratio were determined as in Example 1, and were 10.2 nm and 1.02. Then, the powder X-ray diffractometry was carried out as in Example 1, and it was confirmed that the reaction product (precipitate) was a strontium titanate powder.

Liquids in which the strontium titanate powder and the powdery PMMA were added to N-methylpyrrolidone in predetermined proportions indicated in Table 2 were thereafter subjected to the coating material fabrication, the coating, the drying, and the refractive index measurement of the coating film as in Example 1, and the refractive index of the strontium titanate powder was calculated, and was 2.3.

Here, the formulation number 2-1 in Table 2 was data of a blank coating film composed only of a matrix.

TABLE 2

| | Formulation Number | | | | |
|---|---|---|---|---|---|
| | 2-1 | 2-2 | 2-3 | 2-4 | 2-5 |
| NMP Mass (g) | 2.17 | 2.17 | 2.17 | 2.17 | 2.17 |
| Powder Mass (g) | 0 | 0.165 | 0.271 | 0.452 | 0.625 |
| PMMA Mass (g) | 0.276 | 0.237 | 0.212 | 0.170 | 0.129 |
| Powder Volume | 0 | 14 | 23 | 38 | 53 |
| Fraction (%) | | | | | |
| PMMA Volume | 100 | 86 | 77 | 62 | 47 |
| Fraction (%) | | | | | |
| Coating Film | 1.49 | 1.61 | 1.67 | 1.81 | 1.94 |
| Refractive Index | | | | | |

### Example 3

The reaction was carried out as in Example 2, except for altering the concentration of water to 20 (mol/L), to thereby obtain a precipitate. A part of the precipitate was dispersed in isopropyl alcohol, and subjected to TEM observation as in Example 2, and the formation of particles having TEM images having a particle diameter of 50 nm or smaller and being polygonal and isotropic was confirmed. For the 100 particle images, the average particle diameter and the average aspect ratio were determined as in Example 1, and were 43.2 nm and 1.12. Then, the powder X-ray diffractometry was carried out as in Example 2, and it was confirmed that the reaction product (precipitate) was a strontium titanate powder.

Liquids in which the strontium titanate powder and the powdery PMMA were added to N-methylpyrrolidone in predetermined proportions indicated in Table 3 was thereafter subjected to the coating material fabrication, the coating, the drying, and the refractive index measurement of the coating film as in Example 1, and the refractive index of the strontium titanate powder was calculated, and was 2.5.

Here, the formulation number 3-1 in Table 3 was data of a blank coating film composed only of a matrix.

TABLE 3

| | Formulation Number | | | | | |
|---|---|---|---|---|---|---|
| | 3-1 | 3-2 | 3-3 | 3-4 | 3-5 | 3-6 |
| NMP Mass (g) | 2.17 | 2.17 | 2.17 | 2.17 | 2.17 | 2.17 |
| Powder Mass | 0 | 0.093 | 0.165 | 0.271 | 0.452 | 0.625 |
| (g) | | | | | | |
| PMMA Mass | 0.276 | 0.254 | 0.237 | 0.212 | 0.170 | 0.129 |
| (g) | | | | | | |
| Powder | 0 | 8 | 14 | 23 | 38 | 53 |
| Volume | | | | | | |
| Fraction (%) | | | | | | |
| PMMA | 100 | 92 | 86 | 77 | 62 | 47 |
| Volume | | | | | | |
| Fraction (%) | | | | | | |
| Coating Film | 1.49 | 1.60 | 1.65 | 1.73 | 1.87 | 2.05 |
| Refractive | | | | | | |
| Index | | | | | | |

### Example 4

A flask of 200 mL in volume was placed in a glove box whose atmosphere was replaced by a nitrogen gas. About 60 mL of 2-methoxyethanol (purity: 99% or higher, made by Wako Pure Chemical Industries, Ltd.) was charged therein, and 0.66 g (0.0048 mol) of a metallic barium (purity: 99% or higher, made by Nakalai Tesque, Inc.), 0.42 g (0.0048 mol) of a metallic strontium (purity: 95% or higher, made by Kanto Chemical Co., Inc.), and 2.19 g (0.0096 mol) of tetraethoxytitanium (purity: 97%, made by Tokyo Chemical Industry Co., Ltd.) were further added. After the metallic barium, the metallic strontium and the tetraethoxytitanium were completely dissolved, the liquid was refluxed for 2 hours; and a liquid in which 32.4 g (1.8 mol) of water (distilled water) was diluted with 2-methoxyethanol by adjusting the amount of the 2-methoxyethanol so that the total liquid amount became 120 mL was added under stirring in a constant-temperature bath held at 70° C. The concentrations of the respective components at this time were 0.04 (mol/L) of barium and strontium each, 0.08 (mol/L) of tetraethoxytitanium and 15 (mol/L) of water.

Thereafter, after the liquid was continuously stirred to allow the liquid to react as in Example 1, the liquid was cooled, and subjected to centrifugal separation to thereby obtain a precipitate. A part of the precipitate was used for the transmission electron microscope (TEM) observation as in Example 1.

The TEM observation confirmed the formation of particles having TEM images having a particle diameter of 50 nm or smaller and being polygonal and isotropic. Thereafter as in Example 1, the average particle diameter and the average aspect ratio were calculated, and were 18.6 nm and 1.11, respectively. Then as in Example 1, the powder X-ray diffractometry was carried out, and a diffraction line was confirmed at an intermediate position between a diffraction line position of barium titanate and a diffraction line position of strontium titanate. Further, a part of the precipitate was used, and subjected to a composition analysis by an inductively coupled plasma emission spectrometer (SPS-1700R, made by Seiko Instruments Inc.); and it was thereby confirmed that barium and strontium were contained in a molecular ratio of 1:1 in the precipitate, and the reaction product (precipitate) was a barium strontium titanate (Ba_{0.5}Sr_{0.5}TiO₃).

Liquids in which the barium strontium titanate powder and the powdery PMMA were added to N-methylpyrrolidone in predetermined proportions indicated in Table 4 were thereafter subjected to the coating material fabrication, the coating, the drying, and the refractive index measurement of the coating film as in Example 1, and the refractive index of the barium strontium titanate powder was calculated, and was 2.4.

Here, the formulation number 4-1 in Table 4 was data of a blank coating film composed only of a matrix.

TABLE 4

| | Formulation Number | | | | |
|---|---|---|---|---|---|
| | 4-1 | 4-2 | 4-3 | 4-4 | 4-5 |
| NMP Mass (g) | 2.17 | 2.17 | 2.17 | 2.17 | 2.17 |
| Powder Mass (g) | 0 | 0.180 | 0.295 | 0.491 | 0.679 |
| PMMA Mass (g) | 0.276 | 0.237 | 0.212 | 0.170 | 0.129 |
| Powder Volume | 0 | 14 | 23 | 38 | 53 |
| Fraction (%) | | | | | |
| PMMA Volume | 100 | 86 | 77 | 62 | 47 |
| Fraction (%) | | | | | |
| Coating Film | 1.49 | 1.62 | 1.70 | 1.83 | 1.98 |
| Refractive Index | | | | | |

### Example 5

After the metallic barium, tetraethoxytitanium and water were continuously stirred in 2-methoxyethanol at 70° C. for 5 hours to allow the liquid to react as in Example 1, an ultrasonic vibration was impressed for 30 min to the liquid. Thereafter, 0.466 g (0.449 mL) of methacryloxypropyltrimethoxysilane (MPTMS) being a silane coupling agent (KBM-503, made by Shin-Etsu Chemical Co., Ltd.) was added, and further stirred at 70° C. for 1 hour to subjecting the barium titanate powder to a silane coupling treatment. From liquids in which the barium titanate powder having been subjected to the silane coupling treatment and the powdery PMMA were added to N-methylpyrrolidone (NMP), a coating material was fabricated thereafter as in Example 1. The coating material was dropwise placed and coated on a silicon wafer base material, and the refractive index of the powder was calculated from the measured refractive index of the coating film, and was 2.2. The film thickness of the coating film was measured by the same apparatus (a prism coupler, model: 2010, made by Metricon Corp.), and the results are shown in Table 5. After the coating material was dropwise placed on a glass substrate, the light transmittance of a coating film obtained by coating and drying the coating material as in Example 1 was measured using a spectrophotometer (V-650, made by JASCO Corp.), and the absorption coefficient of the coating film was calculated using Expression (1) from the light transmittance and the measurement value of the film thickness, and is shown in Table 5.

Here, the formulation number 5-1 in Table 5 was data of a blank coating film composed only of a matrix.

TABLE 5

| | Formulation Number | | | |
|---|---|---|---|---|
| | 5-1 | 5-2 | 5-3 | 5-4 |
| NMP Mass (g) | 2.17 | 2.17 | 2.17 | 2.17 |
| Powder Mass (g) | 0 | 0.318 | 0.530 | 0.733 |
| PMMA Mass (g) | 0.276 | 0.212 | 0.170 | 0.129 |
| Powder Volume Fraction (%) | 0 | 23 | 38 | 53 |
| PMMA Volume Fraction (%) | 100 | 77 | 62 | 47 |
| Coating Film Refractive | 1.49 | 1.65 | 1.76 | 1.87 |
| Index | | | | |
| Coating Film Thickness (μm) | 1.4 | 1.5 | 1.6 | 1.6 |
| Light Transmittance (I/I₀) | 92 | 89 | 87 | 85 |
| Absorption Coefficient (α) | 0.06 | 0.08 | 0.09 | 0.10 |
| (μm⁻¹) | | | | |

### Comparative Example 1

A separable flask of 300 mL in volume was placed in a glove box whose atmosphere was replaced by a nitrogen gas. About 40 mL of ethanol was charged therein, and 1.10 g (0.008 mol) of the metallic barium and 1.82 g (0.008 mol) of tetraethoxytitanium were further added. After the metallic barium and the tetraethoxytitanium were completely dissolved, the liquid was refluxed at 73° C. for 2 hours; and to the liquid, a mixed solution of 14.2 g (11.2 mL) of ethanol and 28.8 g of water was added, and stirred at 70° C. for 5 hours to allow the liquid to react. The concentrations of the respective components were 0.1 (mol/L) of barium and tetraethoxytitanium each, and 20 (mol/L) of water.

The liquid after the reaction was subjected to centrifugal separation as in Example 1 to obtain a precipitate, which was subjected to TEM observation, which revealed that the particles were aggregated and the measurements of the average particle diameter and the average aspect ratio were difficult. It was also confirmed by powder X-ray diffractometry that the precipitate was barium titanate.

### Comparative Example 2

After the metallic barium, the tetraethoxytitanium and water were stirred in ethanol at 70° C. for 5 hours to allow the liquid to react as in Comparative Example 1, an ultrasound vibration was applied for 30 min to the liquid; and 0.558 g (0.561 mL) of methacryloxypropyltrimethoxysilane (MPTMS) was added thereto, and further stirred at 70° C. for 1 hour to subject the reaction product to a silane coupling treatment. The liquid after the treatment was cooled and preparatively collected; and a precipitate obtained by carrying out the centrifugal separation on the liquid as in Example 1 was subjected to TEM observation, which revealed that the particles were aggregated and the measurements of the average particle diameter and the average aspect ratio were difficult. It was also confirmed by powder X-ray diffractometry that the precipitate was barium titanate. Using liquids each in which the barium titanate powder remaining after the treatment and the powdery PMMA were added in predetermined proportions indicated in Table 5 to NMP, a coating material was fabricated thereafter as in Example 1. After the coating material was dropwise placed on a glass substrate, the light transmittance of a coating film obtained by coating and drying the coating material as in Example 4 was measured using a spectrophotometer (V-650, made by JASCO Corp.), and the absorption coefficient of the coating film was calculated using Expression (1) from the light transmittance and the measurement value of the film thickness, and is shown in Table 6.

Here, the formulation number 6-1 in Table 6 was data of a blank coating film composed only of a matrix.

TABLE 6

| | Formulation Number | | | |
|---|---|---|---|---|
| | 6-1 | 6-2 | 6-3 | 6-4 |
| NMP Mass (g) | 2.17 | 2.17 | 2.17 | 2.17 |
| Powder Mass (g) | 0 | 0.318 | 0.530 | 0.733 |
| PMMA Mass (g) | 0.276 | 0.212 | 0.170 | 0.129 |
| Powder Volume Fraction (%) | 0 | 23 | 38 | 53 |
| PMMA Volume Fraction (%) | 100 | 77 | 62 | 47 |
| Coating Film Thickness (μm) | 1.4 | 1.5 | 1.6 | 1.5 |
| Light Transmittance (I/I₀) | 92 | 75 | 69 | 63 |
| Absorption Coefficient (α) | 0.06 | 0.19 | 0.23 | 0.31 |
| (μm⁻¹) | | | | |

### INDUSTRIAL APPLICABILITY

Since the high-refractive index powder according to the present invention, and the coating material, the transparent film and the base material with the transparent film, which are made by dispersing the powder, exhibit both a high refractive index and a high light transmittance, these have excellent optical properties, and are suitably used as antireflection materials, condenser materials, lens materials and the like.

1. A powder of a titanate compound of an alkaline earth metal, having an average particle diameter of 50 nm or smaller, an average aspect ratio of 1.0 to 1.2 and a refractive index of 1.8 to 2.6, and comprising a compound represented by MTiO₃ (M is one or two or more selected from the group consisting of Ba, Sr, Ca and Mg).

2. The powder of a titanate compound of an alkaline earth metal according to claim 1, wherein the compound represented by MTiO₃ is at least one of barium titanate [BaTiO₃], strontium titanate [SrTiO₃], and barium strontium titanate [(BaxSr₁₋ₓ)TiO₃, wherein x is a number greater than 0 and less than 1].

3. The powder of a titanate compound of an alkaline earth metal according to claim 1, which is surface-treated with a silane coupling agent.

4. A production method of producing a powder of a titanate compound of an alkaline earth metal according to claim 1, comprising adding an alkaline earth metal and an alkoxytitanium to an alcohol having an alkoxy group, and then adding water thereto,
wherein (A) an atom of the alkaline earth metal and a titanium atom contained in the alkoxytitanium are equimolar; and (B) concentrations of each components based on a total volume of the alcohol having an alkoxy group and the water after addition of the water are the following (i) to (iii):
(i) 0.05 to 0.15 (mol/L) of the alkaline earth metal;
(ii) 0.05 to 0.15 (mol/L) of the alkoxytitanium; and
(iii) 10 to 30 (mol/L) of the water.

5. A coating material for forming a transparent film, comprising a powder of a titanate compound of an alkaline earth metal according to claim 1, a matrix for forming a transparent film, and a solvent,
wherein a volume fraction of the powder of a titanate compound of an alkaline earth metal is 5 to 60% by volume with respect to a total volume of the powder of a titanate compound of an alkaline earth metal and the matrix for forming a transparent film.

6. The coating material for forming a transparent film according to claim 5, wherein the matrix for forming a transparent film comprises a (meth)acrylic polymer and/or a (meth)acrylic monomer.

7. A transparent film formed of the coating material for forming a transparent film according to claim 5,
wherein the transparent film has a refractive index of 1.6 to 2.2 and an absorption coefficient (α) represented by the following Expression (1) of 0.10 (μm⁻¹) or lower:
α=−2.303×(1/L)×log₁₀(I/I₀) Expression (1)
wherein L is a thickness of a coating film (μm), I₀ is an intensity of an incident light in the direction perpendicular to the coating film, I is an intensity of a transmitted light in the direction perpendicular to the coating film, and (I/I₀) is a transmittance.

8. A base material with a transparent film, having the transparent film according to claim 7 formed singly or together with another film on a surface of the base material.
